(19) United States
(12) Patent Application Publication
(10) Pub. No.: US 2025/0257249 A1
(43) Pub. Date: Aug. 14, 2025

(54) Water-based chitosan/citric acid supramolecular adhesive and preparation method and use thereof

(71) Applicant: Northeast Forestry University, Harbin City, Heilongjiang Province (CN)

(72) Inventors: Shaoliang XIAO, Harbin (CN); Lijian CAI, Harbin (CN); Jian LI, Harbin (CN); Yanjun XIE, Harbin (CN); Zetan LU, Harbin (CN)

(21) Appl. No.: 18/852,452

(22) PCT Filed: Apr. 9, 2024
(86) PCT No.: PCT/CN2024/086785

§ 371 Date: Sep. 28, 2024

(30) Foreign Application Priority Data
Aug. 7, 2023 (CN) 2023109845178

(51) Int. Cl. C09J 105/08; B27D 1/06; B27N 3/00; B27N 3/02; C09J 11/04; C09J 11/06

(52) U.S. Cl. CPC C09J 105/08; B27N 3/002; C09J 11/04; C09J 11/06; B27D 1/06; B27N 3/02

(57) ABSTRACT

The invention discloses a water-based chitosan/citric acid supramolecular adhesive and a preparation method and use thereof, and belongs to the technical field of adhesives. The invention solves the problems of existing biological adhesives with uncontrollable viscosity, low bonding strength and poor water resistance, need of energy input in the synthesis process, long synthesis time and failure in use for bonding different wooden units. The water-based chitosan/citric acid supramolecular adhesive includes water, chitosan, citric acid and filler. The method comprises: mixing and dissolving at normal temperature. The water-based chitosan/citric acid supramolecular adhesive is used for preparation of plywood, laminated veneer lumber, particleboard, fiberboards or core-boards. The invention is applied to a water-based chitosan/citric acid supramolecular adhesive and a preparation method and use thereof.

### BACKGROUND OF THE PRESENT INVENTION

The present invention belongs to the technical field of adhesives.

### DESCRIPTION OF RELATED ARTS

Sustainable bio-based materials made of wood as a basic unit are closely related to people's lives, such as plywood, particleboard, and fiberboards for furniture and laminated veneer lumber for structural constructions. Most of them are made of wood and adhesives, but the adhesives used are almost all petroleum-derived resins with formaldehyde as a constituent unit, such as urea-formaldehyde resin, formaldehyde-melamine resin and phenol-formaldehyde resin, which will continuously release formaldehyde and other volatile organic compounds during use. Formaldehyde has been listed as a carcinogen and teratogen by the World Health Organization due to its great harm to the human body. So people have to seek safer and more environmentally friendly adhesives. Currently, the development of wood adhesives made from natural renewable materials, such as soy protein-based adhesives, lignin-based adhesives, and starch-based adhesives, has attracted great attention. They have shown great potential to replace aldehyde resins in the application in artificial boards. However, these bio-based adhesives still have many problems. For example, soy protein, lignin and starch are all high-molecular biomass raw materials. The adhesives prepared from these raw materials often have high viscosity, greater than 5000 mPa·S, and their viscosity is uncontrollable. So these adhesives are only suitable for a current commercial adhesive application process (roller coating) for wood-based panel plywood, and cannot be applied to an adhesive application process for particleboard. The commercial adhesive application process for particleboard is spray coating, which requires adhesives to have a viscosity of 1000 mPa·S or below. As a result, current bio-based adhesives can only be used for bonding of wood veneer biocomposites, and cannot be used for bonding of other non-veneer materials such as particleboard. In addition, soy protein and starch have weak adhesion, poor water resistance, and poor cohesion, and often require chemical modification or blending with current traditional resins such as epoxy resins, polyurethane resins, etc. to improve their adhesion and increase their cohesion, which will undoubtedly increase the cost of bio-based adhesives. Moreover, these adhesives require energy input during the preparation process, and most of them are synthesized on the condition of a high temperature for several hours, which runs counter to the current strategy of carbon peaking and carbon neutrality.

Citric acid is a low-molecular organic acid with abundant reserves in nature. It is widely present in plant fruits, animal bones, muscles, and blood and has the advantages of being renewable, antiseptic, mildew-resistant, and environmentally friendly. Moreover, citric acid with two active functional groups (carboxyl and hydroxyl) has excellent adhesion when combined with polar materials (such as wood) and has been used in the adhesive bonding of fiberboards and particleboard. However, citric acid has the following problems. With low viscosity, citric acid, when used as an adhesive, can easily penetrate into pores of porous wood during an application process, causing waste and failing to form a continuous adhesive film on the veneer, resulting in the problems of low bonding strength and poor water resistance (no resistance to boiling water).

Chitosan is a product of partial deacetylation of chitin from shrimp shells, crab shells, etc. Similar to the structure of cellulose, chitosan with abundant hydroxyl groups will reform abundant hydrogen bonds after dissolution. Moreover, because chitosan is a high-molecular biomass raw material in which molecules will be entangled and the interaction between molecules will be enhanced, adhesives mainly comprising chitosan have a low solid content (<10 wt %) and a high viscosity and easily causes bulges when used for veneer bonding.

### SUMMARY OF THE PRESENT INVENTION

To solve the problems of existing biological adhesives with uncontrollable viscosity, poor bonding strength and poor water resistance, need of energy input in the synthesis process, long synthesis time and failure in use for bonding different wooden units, the present invention provides a water-based chitosan/citric acid supramolecular adhesive and a preparation method and use thereof.

A water-based chitosan/citric acid supramolecular adhesive includes, by mass, 50-70 parts of water, 1.5-10 parts of chitosan, 10-40 parts of citric acid and 0-20 parts of filler.

A preparation method of a water-based chitosan/citric acid supramolecular adhesive includes the following steps:

weighing 50-70 parts of water, 1.5-10 parts of chitosan, 10-40 parts of citric acid and 0-20 parts of filler by mass and performing mixing and dissolving at room temperature to obtain a water-based chitosan/citric acid supramolecular adhesive.

The invention discloses a use of a water-based chitosan/citric acid supramolecular adhesive in the preparation of plywood, laminated veneer lumber, particleboard, fiberboards or core-boards.

The beneficial effects of the present invention are as follows:
(1) The main raw materials of the water-based chitosan/citric acid supramolecular adhesive are chitosan, citric acid and water. The raw materials are non-toxic and water serves as a solvent, so the water-based chitosan/citric acid supramolecular adhesive is green and environmentally friendly without any formaldehyde added.
(2) The preparation process of the water-based chitosan/citric acid supramolecular adhesive is simple. The water-based chitosan/citric acid supramolecular adhesive which only has two main components (chitosan and citric acid) is prepared just by mixing and dissolving within a short time, by aid of very simple equipment under mild reaction conditions, with no need of energy input, so the scale-up of the operation process and industrial production can be realized very easily.
(3) The water-based chitosan/citric acid supramolecular adhesive has a very long trial period. The prepared adhesive has a working life of one month or more. A veneer composite material (plywood) prepared with the adhesive that has been stored for more than one month is almost the same as or better than plywood prepared with a freshly prepared adhesive in terms of boiling water resistance and shear strength.
(4) The water-based chitosan/citric acid supramolecular adhesive, when used for bonding biomass composite materials, needs a simple curing condition without addition of any curing agent. The technique of using the water-based chitosan/citric acid supramolecular adhesive for bonding biomass composite materials can completely adopt a traditional liquid sizing process, which is simple, efficient, and particularly easy to put into mass production.
(5) In terms of the entire production process, the biomass materials bonded by the water-based chitosan/citric acid supramolecular adhesive are non-toxic and harmless to consumers, industrial producers and the environment. The water-based chitosan/citric acid supramolecular adhesive is a truly healthy and environmentally friendly adhesive that complies with the principle of atomic economy. A finished plywood of a veneer composite material prepared with the adhesive shows that the properties fully meet the requirements of the latest national standard (GB/T 9846-2015) for Class I and Class II plywood; the water resistance of veneer laminated lumber composited of the adhesive and veneer can meet the requirements of the national standard (GB/T 20241-2021) for impregnation peeling of structural veneer laminated lumber; a finished particleboard of a non-veneer composite material shows that the properties fully meet the requirements of the latest national standard (GB/T 4897-2015) for particleboard (P5 type). To sum up, the present invention breaks the technical limitation that bio-based adhesives can only be used for bonding veneer composite materials, and breaks through the technical bottleneck of the current organic solvent formaldehyde-based bonding mode. A water-based, formaldehyde-free, sustainable and environmentally friendly supramolecular adhesive with great application prospects is provided.

The invention is applied to a water-based chitosan/citric acid supramolecular adhesive and a preparation method and use thereof.

### BRIEF DESCRIPTION OF THE DRAWINGS

FIG. 1 shows the insolubility (%) of a water-based chitosan/citric acid supramolecular adhesive film prepared in Example II before and after heat treatment;

FIG. 2 shows test results of the trial period of the water-based chitosan/citric acid supramolecular adhesive prepared in Example II;

FIG. 3 shows SEM images of the dry bonding interface of a three-layer plywood prepared in Example 2;

FIG. 4 shows SEM images of the bonding interface of the three-layer plywood prepared in Example 2 after an aging resistance bonding strength test;

FIG. 5 shows the failure mode of the three-layer plywood prepared in Example 2 after a dry bonding strength test;

FIG. 6 shows the failure mode of the three-layer plywood prepared in Example 2 after the aging resistance bonding strength test;

FIG. 7 shows results of the impregnation peeling performance test of a six-layer veneer laminated lumber prepared in Example 5;

FIG. 8 shows results of the impregnation peeling performance test of a six-layer veneer laminated lumber prepared in Comparative Experiment 3;

FIG. 9 shows the static bending strength of three-layer particleboards prepared in Comparative Experiment 4 and Example 6;

FIG. 10 shows the internal bonding strength of the three-layer particleboards prepared in Comparative Experiment 4 and Example 6;

FIG. 11 shows the 24 h water absorption thickness expansion (%) of the three-layer particleboards prepared in Comparative Experiment 4 and Example 6; and

FIG. 12 shows the failure mode of the three-layer particleboard prepared in Example 6 after an internal bonding strength test.

### DETAILED DESCRIPTION OF THE PREFERRED EMBODIMENT

Specific Example I: Disclosed was a water-based chitosan/citric acid supramolecular adhesive in this example includes, by mass, 50-70 parts of water, 1.5-10 parts of chitosan, 10-40 parts of citric acid and 0-20 parts of filler.

The principle was as follows: this specific example developed a novel supramolecular adhesive with controllable viscosity and a dynamic three-dimensional network structure on the basis of a supramolecular self-assembly strategy. The adhesive was prepared easily and was obtained by dissolving chitosan and citric acid in water in one step at room temperature.

Based on the supramolecular self-assembly strategy, this specific example skillfully adjusted the compounding ratio of chitosan and citric acid according to the characteristics of chitosan and citric acid to prepare a novel supramolecular adhesive with controllable viscosity. In the novel supramolecular adhesive, the protonated amino groups of chitosan form ionic crosslinks with the carboxylate ions of citric acid. In the meanwhile, the hydroxyl groups in the chitosan and citric acid molecules also form hydrogen bonds to coordinate the supramolecular self-assembly process and form a dynamic three-dimensional network structure. This novel supramolecular adhesive has suitable viscosity and good film-forming properties. The film can be quickly cured after being heated. The dynamic three-dimensional network structure is transformed into a stable three-dimensional network structure and forms an insoluble thermosetting resin. After being treated with boiling water for four hours, the insolubility (%) can reach 80% or above. The cured resin has high water resistance. Biocomposites (such as plywood, veneer laminated lumber, and particleboard) made using this novel supramolecular adhesive also have high water resistance. For instance, the water resistance of plywood composited of this adhesive and veneer can meet the requirements of the national standard GB/T 9846-2015 for the highest level of weather resistance (Type I and II plywood); the water resistance of veneer laminated timber composited of this adhesive and veneer can meet the requirements of the national standard GB/T 20241-2021 for impregnation peeling of structural veneer laminated timber; the water resistance of three-layer particleboard composited of this adhesive, coarse wood shavings and fine wood shavings can meet the requirements of the national standard GB/T 4897-2015 for ordinary particleboard (P5 type) used in humid conditions. This novel adhesive solves the problems of low viscosity, poor bonding strength and poor water resistance occurring in citric acid used as an adhesive and also solves the problems of low solid content, high viscosity and high risk of bulging occurring in chitosan used as an adhesive. In addition, this specific example also solves the problem that current bio-based adhesives cannot achieve bonding between different wooden units, and broadens the use of bio-based adhesives in high-performance biomass composite materials. The raw materials of this adhesive are environmentally friendly and renewable, the only solvent used is aqueous solution, and the synthesis process is low-carbon and environmentally friendly. The biomass composite materials manufactured and used using this adhesive can completely avoid the hazards of free formaldehyde and volatile organic compounds (VOCs). This adhesive is a novel high-performance, environmentally friendly and water-resistant adhesive for biomass composite materials with broad application prospects.

The beneficial effects of this specific example are as follows:
(1) The main raw materials of the water-based chitosan/citric acid supramolecular adhesive are chitosan, citric acid and water. The raw materials are non-toxic and water serves as a solvent, so the water-based chitosan/citric acid supramolecular adhesive is green and environmentally friendly without any formaldehyde added.
(2) The preparation process of the water-based chitosan/citric acid supramolecular adhesive is simple. The water-based chitosan/citric acid supramolecular adhesive which only has two main components (chitosan and citric acid) is prepared just by mixing and dissolving within a short time, by aid of very simple equipment under mild reaction conditions, with no need of energy input, so the scale-up of the operation process and industrial production can be realized very easily.
(3) The water-based chitosan/citric acid supramolecular adhesive has a very long trial period. The prepared adhesive has a working life of one month or more. A veneer composite material (plywood) prepared with the adhesive that has been stored for more than one month is almost the same as or better than plywood prepared with a freshly prepared adhesive in terms of boiling water resistance and shear strength.
(4) The water-based chitosan/citric acid supramolecular adhesive, when used for bonding biomass composite materials, needs a simple curing condition without addition of any curing agent. The technique of using the water-based chitosan/citric acid supramolecular adhesive for bonding biomass composite materials can completely adopt a traditional liquid sizing process, which is simple, efficient, and particularly easy to put into mass production.
(5) In terms of the entire production process, the biomass materials bonded by the water-based chitosan/citric acid supramolecular adhesive are non-toxic and harmless to consumers, industrial producers and the environment. The water-based chitosan/citric acid supramolecular adhesive is a truly healthy and environmentally friendly adhesive that complies with the principle of atomic economy. A finished plywood of a veneer composite material prepared with the adhesive shows that the properties fully meet the requirements of the latest national standard (GB/T 9846-2015) for Class I and Class II plywood; the water resistance of veneer laminated lumber composited of the adhesive and veneer can meet the requirements of the national standard (GB/T 20241-2021) for impregnation peeling of structural veneer laminated lumber; a finished particleboard of a non-veneer composite material shows that the properties fully meet the requirements of the latest national standard (GB/T 4897-2015) for particleboard (P5 type). To sum up, the present invention breaks the technical limitation that bio-based adhesives can only be used for bonding veneer composite materials, and breaks through the technical bottleneck of the current organic solvent formaldehyde-based bonding mode. A water-based, formaldehyde-free, sustainable and environmentally friendly supramolecular water-based adhesive with great application prospects was provided.

Specific Example II: This example is the same as Specific Example I except that the water was one or more of tap water, mineral water, spring water, distilled water, purified water, deionized water, ultrapure water and industrial water.

Specific Example III: This example is the same as Specific Example I or Specific Example II except that the chitosan had a relative molecular weight of at least 600 and a deacetylation degree of at least 50%.

Specific Example IV: This example is the same as one of Specific Examples I to III except that the citric acid was one or more of edible citric acid, industrial citric acid, anhydrous citric acid and citric acid monohydrate.

Specific Example V: This example is the same as one of Specific Examples I to IV except that the filler is montmorillonite and/or kaolin.

Specific Example VI: This example disclosed a preparation method of a water-based chitosan/citric acid supramolecular adhesive, which was implemented by the following steps:

50-70 parts of water, 1.5-10 parts of chitosan, 10-40 parts of citric acid and 0-20 parts of filler by mass were weighed and then mixed and dissolved at room temperature to obtain a water-based chitosan/citric acid supramolecular adhesive.

Specific Example VII: This example is the same as Specific Example VI except that the solid content of the water-based chitosan/citric acid supramolecular adhesive was 30wt %-50wt %.

Specific Example VIII: This example disclosed a use of a water-based chitosan/citric acid supramolecular adhesive in the preparation of plywood, laminated veneer lumber, particleboard, fiberboards or core-boards.

The wood species of the board in this specific example was not limited, and it could be any one or more of coniferous wood, broad-leaved wood, bamboo, or other trees; the type of shavings was not limited, and it could be any one or more of coniferous wood, broad-leaved wood, bamboo, or other plants such as straw.

Specific Example IX: This example is the same as Specific Example VIII except that a water-based chitosan/citric acid supramolecular adhesive was used in the preparation of plywood, veneer laminated lumber or particleboard, and this specific example was implemented by the following steps:

in the case of preparation of a plywood or veneer laminated lumber, under a condition that the adhesive application amount per unit area is 100 g/m²-600 g/m², applying the adhesive to one side or two sides, and then performing assembly to obtain a blank; after assembly, pre-pressing the blank first, and then hot pressing the blank for 30 s/mm-180 s/mm at a hot pressing temperature of 120° C.-230° C. and a hot pressing pressure of 0.5 MPa-2 MPa;

in the case of preparation of a particleboard, assembly was performed to obtain a blank after adhesive spraying; then, the blank was pre-pressed first and then hot pressed for 30 s/mm-180 s/mm at a hot pressing temperature of 180° C.-230° C. and a hot pressing pressure of 2.2 MPa-4 MPa, where the amount of the adhesive sprayed satisfied the percentage of solid mass in the adhesive to the absolute dry mass of shavings being 4%-20%.

In this specific example, hot pressing for 30 s/mm-180 s/mm specifically refers to hot pressing for 30 s-180 s at a unit thickness of 1 mm.

Specific Example X: This example is the same as Specific Example VIII or IX except that: in the case of preparation of a plywood or veneer laminated lumber, the blank was pre-pressed at room temperature and a pre-pressing pressure of 0.5 MPa-1 MPa for 30 min or more; in the case of preparation of a particleboard, the blank was pre-pressed at room temperature and a pre-pressing pressure of 0.5 MPa-1 MPa for 10 s-60 s.

The beneficial effects of the present invention were verified by the following examples.

### Example I

Disclosed was a water-based chitosan/citric acid supramolecular adhesive including, by mass, 50 parts of water, 10 parts of chitosan, and 40 parts of citric acid.

The water used was distilled water.

The chitosan had a relative molecular weight of 600,000 and a deacetylation degree of 85%.

The citric acid used was citric acid monohydrate

Further disclosed was a preparation method of the described water-based chitosan/citric acid supramolecular adhesive, which was implemented by the following steps:

50 parts of water, 10 parts of chitosan, and 40 parts of citric acid by mass were weighed and then mixed and dissolved at room temperature to obtain the water-based chitosan/citric acid supramolecular adhesive.

The water-based chitosan/citric acid supramolecular adhesive had a solid content of 50 wt % and a viscosity of 72500 mPa·s.

Example II: This example is the same as Example I except that disclosed was a water-based chitosan/citric acid supramolecular adhesive, including, by mass, 70 parts of water, 4 parts of chitosan, and 26 parts of citric acid.

The water-based chitosan/citric acid supramolecular adhesive had a solid content of 30 wt % and a viscosity of 14700 mPa·s.

Example III: This example is the same as Example I except that disclosed was a water-based chitosan/citric acid supramolecular adhesive, including, by mass, 70 parts of water, 2 parts of chitosan, and 28 parts of citric acid.

The water-based chitosan/citric acid supramolecular adhesive had a solid content of 30wt % and a viscosity of 467 mPa·s.

Comparative Experiment I: This example is the same as Example I except that disclosed was a citric acid-based adhesive, including, by mass, 70 parts of water and 30 parts of citric acid.

The citric acid-based adhesive had a solid content of 30wt % and a viscosity of 2.4 mPa·s.

Comparative Experiment II: This example is the same as Example I except that disclosed was a chitosan-based adhesive, including, by mass, 96 parts of water, 3 parts of chitosan, and 1 part of acetic acid.

The acetic acid used was glacial acetic acid with a mass percentage of 99.5%;

the chitosan-based adhesive had a solid content of 4wt % and a viscosity of 865 mPa·s.

### Example 1

A plywood was prepared using the water-based chitosan/citric acid supramolecular adhesive prepared in Example II, specifically by the following steps:

A peeled poplar veneer was dried at room temperature to a moisture content of 7%; under a condition that the adhesive application amount per unit area was 280 g/m² per unit area, the adhesive was applied to two sides to obtain a coated core board; a face plate and the coated core board were assembled in a cross-grain manner to obtain a blank; after assembly, the blank was pre-pressed in a pre-pressing machine for 6 h at room temperature and a pressure of 0.5 MPa to obtain a pre-pressed board; the pre-pressed board was hot pressed in a hot press for 80 s/mm at a hot pressing temperature of 170° C. and a hot pressing pressure of 1 MPa to obtain a three-layer plywood.

Example 2: This example is the same as Example 1 except that: a plywood was prepared using the water-based chitosan/citric acid supramolecular adhesive prepared in Example I, and the hot pressing was performed for 120 s/mm at a hot pressing temperature of 160° C. and a hot pressing pressure of 1 MPa.

Example 3: This example is the same as Example 1 except that: the hot pressing was performed for 30 s/mm at a hot pressing temperature of 180° C. and a hot pressing pressure of 1 MPa.

Example 4: This example is the same as Example 1 except that: the hot pressing was performed for 30 s/mm at a hot pressing temperature of 170° C. and a hot pressing pressure of 1 MPa.

Comparative Experiment 1: This comparative experiment is the same as Example 1 except that: a plywood was prepared using the citric acid-based adhesive prepared in Comparative Experiment I, and the hot pressing was performed for 30 s/mm at a hot pressing temperature of 200°° C. and a hot pressing pressure of 1 MPa.

Comparative Experiment 2: This comparative experiment is the same as Example 1 except that: a plywood was prepared using the chitosan-based adhesive prepared in Comparative Experiment II, and the hot pressing was performed for 30 s/mm at a hot pressing temperature of 200° C. and a hot pressing pressure of 1 MPa.

### Example 5

A veneer laminated lumber was prepared using the water-based chitosan/citric acid supramolecular adhesive prepared in Example II, specifically by the following steps:

A peeled poplar veneer was dried at room temperature to a moisture content of 7%; under a condition that the adhesive application amount per unit area was 400 g/m² per unit area, the adhesive was applied to one side or two sides to obtain a coated core board; a face plate and the coated core board were assembled in a parallel-grain manner to obtain a blank; after assembly, the blank was pre-pressed in a pre-pressing machine for 6 h at room temperature and a pressure of 0.5 MPa to obtain a pre-pressed board; the pre-pressed board was then hot pressed in a hot press for 54 s/mm at a hot pressing temperature of 180° C. and a hot pressing pressure of 1 MPa to obtain a six-layer veneer laminated lumber.

Comparative Experiment 3: This comparative experiment is the same as Example 5 except that: a veneer laminated lumber was prepared using the citric acid-based adhesive prepared in Comparative Experiment I.

### Example 6

A particleboard was prepared using the water-based chitosan/citric acid supramolecular adhesive prepared in Example III, specifically by the following steps:

Cut poplar wood shavings were dried in a drying oven at 80° C. to a moisture content of 5%; after spraying the adhesive, fine shavings spread on upper and lower surfaces and coarse shavings spread in the middle were assembled to obtain a blank; after blank assembly, the blank was pre-pressed in a pre-pressing machine for 30 s at room temperature and a pressure of 0.5 MPa to obtain a pre-pressed board; the pre-pressed board was then hot pressed in a hot press for 180 s/mm at a hot pressing temperature of 180° C. and a hot pressing pressure of 3 MPa to obtain a three-layer particleboard, where the amount of the adhesive sprayed satisfied the percentage of solid mass in the adhesive to the absolute dry mass of shavings being 8%; the coarse wood shavings used had a length of 15 mm-45 mm, a width of 3 mm-10 mm, and a thickness of 0.4 mm-0.7 mm; the fine wood shavings had a length of 3 mm-15 mm, a width of 0.5 mm-1.5 mm, and a thickness of 0.2 mm-0.4 mm.

Comparative Experiment 4: This comparative experiment is the same as Example 6 except that: a particleboard was prepared using the citric acid-based adhesive prepared in Comparative Experiment I.

The adhesive prepared in Examples I to III and Comparative Experiments I and II was tested for solid content with reference to the requirements of the national standard GBT14074-2006 and for viscosity with reference to the national standard GB/T 2794-1995.

The water-based chitosan/citric acid supramolecular adhesive prepared in Example II was applied to a plastic culture dish by a casting method and dried at room temperature to form an adhesive film, i.e., an unheat-treated adhesive film. The unheat-treated adhesive film was then dried in a drying oven at 170° C. until the mass was constant, thus obtaining a heat-treated adhesive film.

The insolubility (%) of the film was determined as follows:

The initial mass of the film is recorded as m₀, and then the film was placed in 100° C. boiling water for 4 h, and then the boiled film was dried in an oven at 63° C. until the mass was stable, and the final mass was recorded as m1. Each film was tested 3 times and an average value was taken. The insolubility (%) was calculated as follows:

$$Insolubility = ( \frac{{m}_{1}}{{m}_{0}} ) \times 100 \% .$$

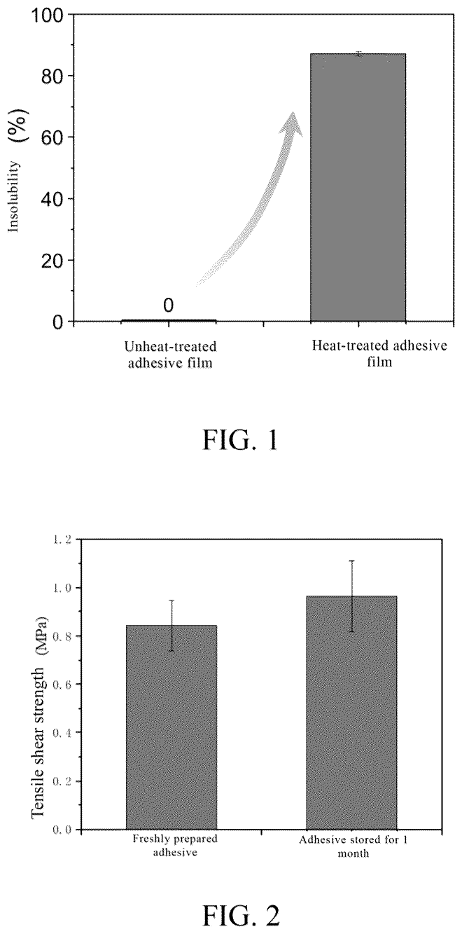

FIG. 1 shows the insolubility (%) of the water-based chitosan/citric acid supramolecular adhesive film prepared in Example II before and after heat treatment. As can be seen, the film was cured after being heated, its dynamic three-dimensional network structure is transformed into a stable three-dimensional network structure, and after four hours of boiling water treatment, the insolubility (%) can reach 80% or above. The insolubility (%) of the film before heat treatment is 0%, and the insolubility (%) of the film after heat treatment is 87.03±0.75%.

The performance indicators of plywood were determined as follows:

Bonding shear strength test: the test was performed with reference to the national standard GB/T 17657-2013 on test samples which were prepared according to the national standard GB/T 17657-2013. In preparation of the test samples, the wood grain direction of the core board between the adhesive layers to be tested should be perpendicular to the length direction of the test samples. The slot width and depth of the test sample were designed in accordance with the illustrated dimensions and requirements specified according to the national standard. According to GB/T 17657-2013, the prepared standard test samples were stored in a desiccator for 2 days and then tested a universal mechanical testing machine (RGT-20), with a 50 KN force sensor and a tensile speed of 5 mm/min.

Dry bonding strength: The prepared standard samples were directly subjected to tensile shear test without any treatment.

Wet bonding strength: According to GB/T 17657-2013, the prepared standard samples were impregnated in 63° C. hot water for 3 h, and then cooled at room temperature for 10 min, and then subjected to tensile shear test.

Aging resistance bonding strength: According to GB/T 17657-2013, the prepared standard samples were impregnated in boiling water for 4 h, then dried in a forced air drying oven at (60±3)° C. for 16 h-20 h, and then impregnated in boiling water for 4 h, and then cooled in cold water with a temperature of below 30° C. for at least 1 h and then subjected to tensile shear test.

From Example 1 and Example 2 in Table 1, it can be seen that the finished plywood of the veneer composite material produced by the adhesives fully meets the requirements of the latest national standard (GB/T 9846-2015) for Class I and Class II plywood. Class II plywood is required to have a wet bonding strength of at least 0.7 MPa, and Class I plywood is required to have an aging resistance bonding strength of at least 0.7 MPa.

TABLE 1
Dry, wet and aging resistance bonding
strength of three-layer plywood

| | Dry bonding | Wet bonding | Aging resistance |
|---|---|---|---|
| | strength | strength | bonding strength |
| Example | (MPa) | (MPa) | (MPa) |
| Example 1 | 1.84 ± 0.12 | 1.44 ± 0.08 | 0.84 ± 0.10 |
| Example 2 | 1.08 ± 0.11 | 1.05 ± 0.15 | 0.80 ± 0.05 |
| Example 3 | 1.31 ± 0.11 | 0.95 ± 0.01 | Failed |
| Example 4 | 1.07 ± 0.19 | 1.01 ± 0.09 | Failed |
| Comparative | Failed | Failed | Failed |
| Example 1 | | | |
| Comparative | 1.36 ± 0.09 | 0.89 ± 0.17 | Failed |
| Example 2 | | | |

The water-based chitosan/citric acid supramolecular adhesive prepared in Example II was stored at room temperature for 1 month, and the plywood was prepared according to Example 1 using the adhesive that has been stored for 1 month and then tested for aging resistance bonding strength, as shown in FIG. 2. FIG. 2 shows test results of the trial period of the water-based chitosan/citric acid supramolecular adhesive prepared in Example II. As can be seen, the trial period of the water-based chitosan/citric acid supramolecular adhesive is very long, and the aging resistance bonding strength of the plywood prepared according to Example 1 using the adhesive that has been stored for 1 month is better than that of the plywood prepared with a freshly prepared adhesive.

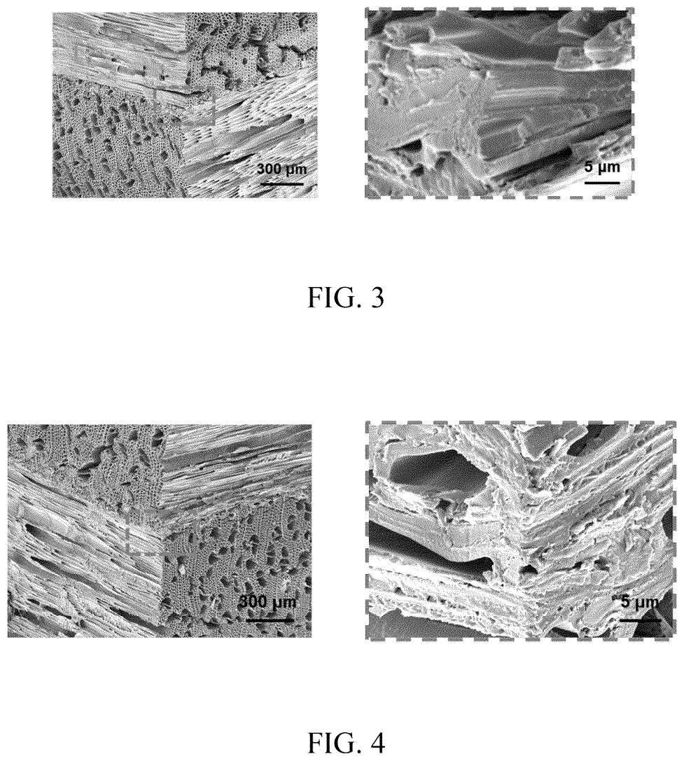

FIG. 3 shows SEM images of the dry bonding interface of a three-layer plywood prepared in Example 2. As can be seen, the adhesive forms a continuous adhesive film at an interface between two wooden units, indicating that the adhesive film has film-forming properties, and after being heated, the adhesive film is quickly cured to form a stable resin and forms a mechanical interlocking structure with the layered porous structure of the wood.

FIG. 4 shows SEM images of the bonding interface of the three-layer plywood prepared in Example 2 after an aging resistance bonding strength test. As can be seen, the continuous adhesive film did not dissolve after the aging treatment and still maintained the original mechanical interlocking structure. Also, it was found that under a condition that the wood cell wall had multiple failures, the bonding interface remained in a closed state, indicating that the adhesive formed an effective bond with the wooden units.

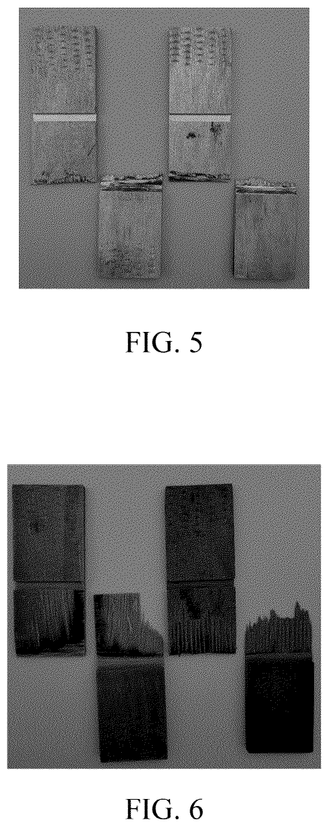

FIG. 5 shows the failure mode of the three-layer plywood of Example 2 after a dry bonding strength test. As can be seen, the resin body strength of the cured adhesive is higher than the strength of the wood.

FIG. 6 shows the failure mode of the three-layer plywood of Example 2 after the aging resistance bonding strength test. As can be seen, the resin body strength of the cured adhesive after aging is stiller higher than the strength of the wood.

The performance indicators of veneer laminated lumber were determined as follows:

Impregnation peeling performance test: The test was performed in accordance with GB/T 20241-2021.

### (1) Cold Water Impregnation Peeling

Test samples were immersed completely in 25° C. water and impregnated for 24 h, and then taken out and dried in a drying oven at (70±3)° C. until the mass of the samples was within 105% of the mass before the test. By observation and measurement, the ratio of peeled adhesive lines on four sides of all adhesive layers to the total length of all adhesive layers and the ratio of the stripping length of any adhesive layer to the sum of the four sides of the adhesive layer were calculated.

### (2) Boiling Water Impregnation Peeling

Test samples were immersed completely in boiling water and impregnated for 4 h and then impregnated in 25° C. water for 1 h, and then dried in a drying oven at (70±3)° C. until the mass of the samples was within 105% of the mass before the test. By observation and measurement, the ratio of peeled adhesive lines on four sides of all adhesive layers to the total length of all adhesive layers and the ratio of the peeling length of any adhesive layer to the sum of the four sides of the adhesive layer were calculated.

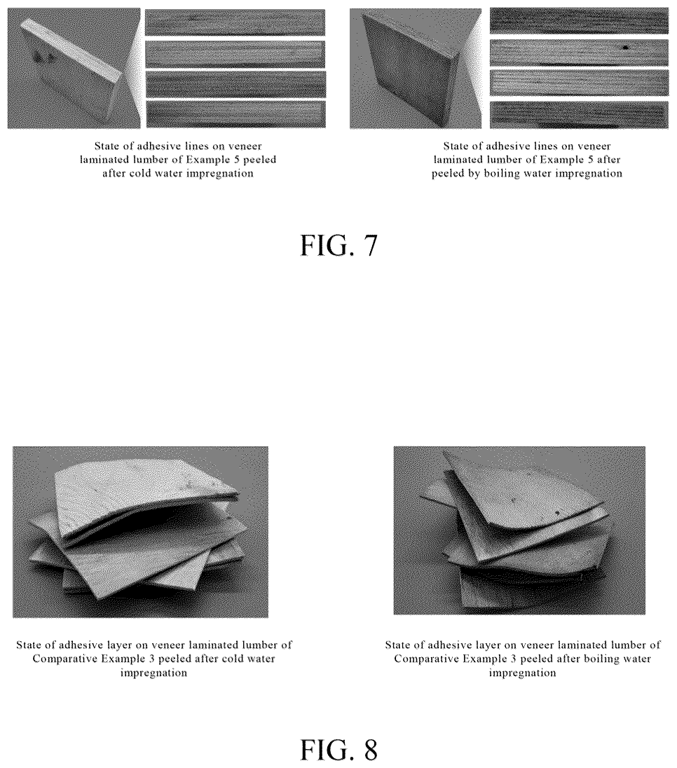

FIG. 7 shows results of the impregnation peeling performance test of the six-layer veneer laminated lumber prepared in Example 5. As can be seen, after the six-layer veneer laminated lumber was peeled by cold water impregnation, the ratio of peeled adhesive lines on the four sides of all the adhesive layers to the total length of all the adhesive layers and the ratio of the peeling length of any adhesive layer to the sum of the four sides of the adhesive layer are both 0%. Also, after the six-layer veneer laminated lumber was peeled by boiling water impregnation, the ratio of the peeled adhesive lines on the four sides of all the adhesive layers to the total length of all the adhesive layers and the ratio of the peeling length of any adhesive layer to the sum of the four sides of the adhesive layer are 0%. The impregnation peeling performance of the six-layer veneer laminated lumber meets the requirements of national standard GB/T 20241-2021 for impregnation peeling of structural veneer laminated lumber.

FIG. 8 shows results of the impregnation peeling performance test of the six-layer veneer laminated lumber prepared in Comparative Experiment 3. As can be seen, after the six-layer veneer laminated lumber was peeled by cold water impregnation, the ratio of peeled adhesive lines on the four sides of all the adhesive layers to the total length of all the adhesive layers and the ratio of the peeling length of any adhesive layer to the sum of the four sides of the adhesive layer are both 100%. Also, after the six-layer veneer laminated lumber was peeled by boiling water impregnation, the ratio of the peeled adhesive lines on the four sides of all the adhesive layers to the total length of all the adhesive layers and the ratio of the peeling length of any adhesive layer to the sum of the four sides of the adhesive layer are 100%. The impregnation peeling performance of the six-layer veneer laminated lumber does not meet the requirements of national standard GB/T 20241-2021 for impregnation peeling of structural veneer laminated lumber.

The performance indicators of particleboard were determined as follows:

(1) Static bending strength test: Samples were prepared and tested according to the national standard GB/T 17657-2013. The samples had a size of 150 mm×50 mm and a span of 100 mm. The force sensor used had a capacity of 50 KN and the loading speed was 5 mm/min.

(2) Internal bonding strength test: Samples were prepared and tested according to the national standard GB/T 17657-2013. The samples had a size of 50 mm×50 mm.

The adhesive used between the samples and a fixture was hot melt adhesive. According to GB/T 17657-2013, the prepared bonding samples were placed in a balancing treatment chamber with a temperature of (20±2)° C. and a relative humidity of (65±5) %. The test should be completed within 1 h after the samples are taken out of the balancing treatment chamber. The force sensor used had a capacity of 50 KN and the tensile speed was 5 mm/min.

(3) 24 h water absorption thickness expansion (%): Samples were prepared and tested according to the national standard GB/T 17657-2013. The samples had a size of 50 mm×50 mm and the water used was tap water with a pH of 7±1. At a temperature of 20±1° C., the samples were immersed in a water tank, and the temperature was unchanged during the test. The surfaces of the samples were perpendicular to the water surface. The distance between the samples and between the sample and the bottom and wall of the water tank was at least 15 mm. The upper parts of the samples were (25±5) mm below the water surface.

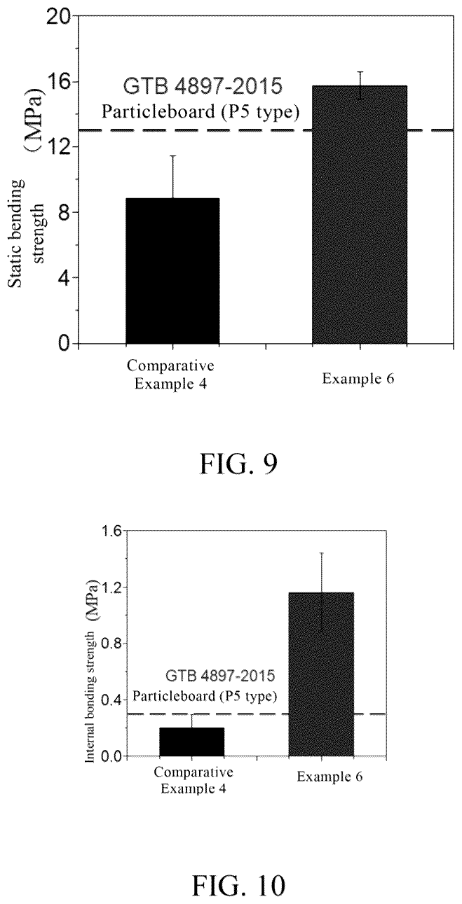

FIG. 9 shows the static bending strength of three-layer particleboards prepared in Comparative Experiment 4 and Example 6. As can be seen, the static bending strength of the three-layer particleboard prepared in Comparative Experiment 4 is 8.84±2.50 MPa, which is lower than the static bending strength requirement of ≥13 MPa for ordinary particleboard (P5 type) used in a wet state in national standard GB/T 4897-2015. The static bending strength of the three-layer particleboard prepared in Example 6 is 15.71+0.83 MPa, which is higher than the static bending strength requirement of ≥13 MPa for ordinary particleboard (P5 type) used in a wet state in national standard GB/T 4897-2015.

FIG. 10 shows the internal bonding strength of the three-layer particleboards prepared in Comparative Experiment 4 and Example 6. As can be seen, the internal bonding strength of the three-layer particleboard prepared in Comparative Experiment 4 is 0.19±0.90 MPa, which is lower than the internal bonding strength requirement of ≥0.30 MPa for ordinary particleboard (P5 type) used in a wet state in national standard GB/T 4897-2015. The internal bonding strength of the three-layer particleboard prepared in Example 6 is 1.16±0.27 MPa, which is higher than the internal bonding strength requirement of ≥0.3 MPa for ordinary particleboard (P5 type) used in a wet state in national standard GB/T 4897-2015.

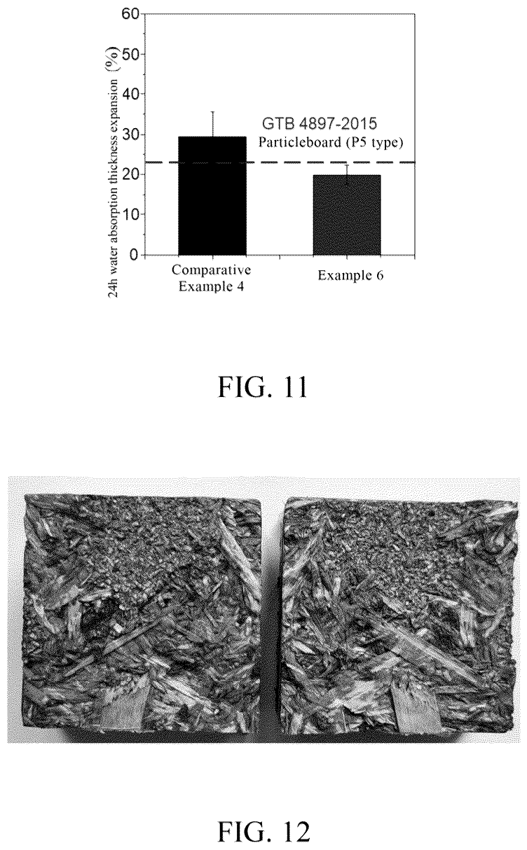

FIG. 11 shows the 24 h water absorption thickness expansion (%) of the three-layer particleboards prepared in Comparative Experiment 4 and Example 6. As can be seen, the 24 h water absorption thickness expansion (%) of the three-layer particleboard prepared in Comparative Experiment 4 is 29.43±6.04%, which does not meet the 24 h water absorption thickness expansion (%) requirement of ≤23% for ordinary particleboard (P5 type) used in a wet state in national standard GB/T 4897-2015. The 24 h water absorption thickness expansion (%) of the three-layer particleboard prepared in Example 6 is 19.90±2.42%, which is higher than the 24 h water absorption thickness expansion (%) requirement of ≤23% for ordinary particleboard (P5 type) used in a wet 10 state in national standard GB/T 4897-2015.

FIG. 12 shows the failure mode of the three-layer particleboard prepared in Example 6 after an internal bonding strength test. As can be seen, the failure mode of the particleboard is multiple wood failures, indicating that the resin strength of the cured adhesive is higher than the body strength of the particleboard.

What is claimed is:

1. A water-based chitosan/citric acid supramolecular adhesive, comprising, by mass, 50-70 parts of water, 1.5-10 parts of chitosan, 10-40 parts of citric acid and 0-20 parts of filler.

2. The water-based chitosan/citric acid supramolecular adhesive according to claim 1, wherein the water is one or more of tap water, mineral water, spring water, distilled water, purified water, deionized water, ultrapure water and industrial water.

3. The water-based chitosan/citric acid supramolecular adhesive according to claim 1, wherein the chitosan has a relative molecular weight of at least 600 and a deacetylation degree of at least 50%.

4. The water-based chitosan/citric acid supramolecular adhesive according to claim 1, wherein the citric acid is one ore more of edible citric acid, industrial citric acid, anhydrous citric acid and citric acid monohydrate.

5. The water-based chitosan/citric acid supramolecular adhesive according to claim 1, wherein the filler is montmorillonite and/or kaolin.

6. A preparation method of the water-based chitosan/citric acid supramolecular adhesive according to claim 1, wherein the preparation method is implemented by the following steps:
weighing 50-70 parts of water, 1.5-10 parts of chitosan, 10-40 parts of citric acid and 0-20 parts of filler by mass and performing mixing and dissolving at room temperature to obtain a water-based chitosan/citric acid supramolecular adhesive.

7. The preparation method of the water-based chitosan/citric acid supramolecular adhesive according to claim 6, wherein the solid content of the water-based chitosan/citric acid supramolecular adhesive is 30 wt %-50 wt %.

8. A use of the water-based chitosan/citric acid supramolecular adhesive according to claim 1 in the preparation of plywood, laminated veneer lumber, particleboard, fiberboards or core-boards.

9. The use of the water-based chitosan/citric acid supramolecular adhesive in the preparation of plywood, laminated veneer lumber, particleboard, fiberboards or core-boards according to claim 8, implemented by the following steps:
in the case of preparation of a plywood or veneer laminated lumber, under a condition that the adhesive application amount per unit area is 100 g/m²-600 g/m², applying the adhesive to one side or two sides, and then performing assembly to obtain a blank; after assembly, pre-pressing the blank first, and then hot pressing the blank for 30 s/mm-180 s/mm at a hot pressing temperature of 120° C.-230° C. and a hot pressing pressure of 0.5 MPa-2 MPa;
in the case of preparation of a particleboard, performing assembly to obtain a blank after adhesive spraying; then, pre-pressing the blank first and then hot pressing the blank for 30 s/mm-180 s/mm at a hot pressing temperature of 180° C.-230° C. and a hot pressing pressure of 2.2 MPa-4 MPa, wherein the amount of the adhesive sprayed satisfies the percentage of solid mass in the adhesive to the absolute dry mass of shavings being 4%-20%.

10. The use of the water-based chitosan/citric acid supramolecular adhesive according to claim 9, wherein in the case of preparation of a plywood or veneer laminated lumber, the pre-pressing is performed at room temperature and a pre-pressing pressure of 0.5 MPa-1 MPa for 30 min or more; in the case of preparation of a particleboard, the pre-pressing is performed at room temperature and a pre-pressing pressure of 0.5 MPa-1 MPa for 10 s-60 s.
